(19) United States
(12) Patent Application Publication
(10) Pub. No.: US 2014/0235429 A1
(43) Pub. Date: Aug. 21, 2014

(54) PROCESS FOR ENHANCING NICKEL TOLERANCE OF HEAVY HYDROCARBON CRACKING CATALYSTS

(71) Applicant: INDIAN OIL CORPORATION LTD., Kolkata, West Bengal (IN)

(72) Inventors: Arumugam Velayutham Karthikeyani, Faridabad (IN); Biswanath Sarkar, Faridabad (IN); Velusamy Chidambaram, Faridabad (IN); Balaiah Swamy, Faridabad (IN); Pankaj Kumar Kasliwal, Faridabad (IN); Ganga Shanker Mishra, Faridabad (IN); Mohan Prabhu Kuvettu, Faridabad (IN)

(73) Assignee: INDIAN OIL CORPORATION LTD., Kolkata, West Bengal (IN)

(21) Appl. No.: 14/347,613

(22) PCT Filed: Oct. 11, 2012
(86) PCT No.: PCT/IB2012/002030

§ 371 Date: Mar. 26, 2014

(30) Foreign Application Priority Data
Oct. 12, 2011 (IN) 1316/KOL/2011

(51) Int. Cl. B01J 29/80

(52) U.S. Cl. CPC B01J 29/80
USPC 502/65; 502/303

(57) ABSTRACT

The invention discloses a process for upgrading feed streams containing residual fractions with high concentrations of metals, more specifically nickel content up to 150 ppm employing acidic catalysts comprising large pore rare earth faujasite zeolite component, pentasil zeolite component and pseudoboehemite containing resid cracking component while the composite is impregnated with lanthanum oxide or aluminium oxide or mixture of both. The hydrocarbon feed stock can be sourced from either petroleum derivatives or from coal, tar or sand. The process results in increased selectivity of propylene in LPG in the range of 39-52%.

### FIELD OF THE INVENTION

The invention relates to fluid catalytic cracking (FCC) processes in general, and to a process for enhancing nickel tolerance of heavy hydrocarbon cracking catalysts for treating heavy hydrocarbon feedstocks in particular. The process is for enhancing yield of LPG and light olefins, especially of C3 and C4 hydro carbons, from various petroleum fractions including heavy residual oils containing high metal content, more specifically nickel, using a novel solid acid catalytic system in a high severity catalytic cracking reaction condition.

### BACKGROUND OF THE INVENTION

Presence of vanadium in the hydrocarbon feed cause maximum destruction of zeolite which is an invaluable and major active component of the typical FCC catalysts. Destruction of zeolite component under fluid catalytic cracking unit regenerator conditions lead to loss of catalytic activity and selectivity. Beyond certain limits of vanadium in the feed, the cracking operation becomes economically unviable due to losses in the yields of valuable products. Presence of nickel in the feed increases dehydrogenation reactions causing higher yields of hydrogen and coke and lower yields of desirable products such as gasoline, LCO etc.

There are a variety of catalyst additives available known in the art which can negate the undesired effects of vanadium and nickel to a certain extent. As the metal levels go up in equilibrium catalyst, catalyst withdrawal and fresh catalyst make-up rate goes on increasing, primarily to retain minimum activity of the catalyst in the inventory of the system. This seriously affects the economics of the process.

In a resid processing fluid catalytic cracking unit it is possible to process only up to 15-20 ppm of vanadium and up to 30 ppm of nickel in the feed with the presently available catalysts, additives and other technologies.

Cracking over nickel laden Y zeolite-based catalysts is highly complex as cracking takes place via acid catalyzed mechanism to produce hydrogen, light hydrocarbons and coke while nickel produces additional hydrogen and coke by dehydrogenation mechanism. Obviously, hydrogen production through the second mechanism is likely to be higher than in the first.

Several nickel passivating agents have been described in various patents. Antimony, bismuth, tin, germanium, gallium, tellurium, indium, thallium manganese, barium etc and their certain combinations can be cited. Most of these passivating agents are used along with feedstock in some proportions. Under today's stringent environment-controlled refinery operations, use of some of these passivators are not desirable.

U.S. Pat. No. 5,064,524 (Betz Laboratories, Inc) describes a method in which Cerium or Cerium containing compounds are used along with feedstock to inhibit the undesired effect of nickel in the cracking reactions. There is no mention of the maximum level of nickel in the feed that can be effectively taken care of.

U.S. Pat. No. 5,001,096 (Mobil Oil Corp) refers to a process of surface coating of discrete catalytic cracking catalyst particles wherein surface coating material consists of rare earth oxide, aluminum oxide and aluminum phosphate. Such surface coating is claimed to be weakly bound to the base FCC catalyst and gradually flake off as the catalysts are circulated in the FCC unit. However the referred patent does not provide any specific data related to quantities of contaminant metals specifically that of Nickel in the feedstock that can be effectively handled without compromising on the desired yields and conversion.

U.S. Pat. No. 5,326,465 (China Petro-Chemical Corporation) claims a catalytic cracking process to produce LPG which is rich in propylene and butylenes and high-octane gasoline using three zeolitic active components namely, rare earth containing high silica pentasil zeolite, rare earth Y zeolite and high silica Y silica. These three components constitute 10-40 wt % of the catalyst and the reminder constitutes silica or silica-alumina binder. Feed may constitute straight run fractions and a maximum 30 wt % of coker gas oil, deasphalted oil or its mixtures. The patent limits itself only to the equilibrium catalyst with a maximum of 20,000 ppm of nickel equivalent.

U.S. Pat. No. 4,980,053 (Research Institute of Petroleum Processing, SINOPEC) describes a process for production of LPG rich in propylene and butylene from vacuum gas oil feedstock using pentasil and faujasite catalysts in a fluid catalytic cracking process at a reaction temperature of 500-650° C. with a catalyst to oil ratio of 2-12. The process claims to yield 15 wt % each of propylene and butylenes based on feed. There is neither any claim on the characteristics of feed stocks in terms of Canradson Carbon Residue (CCR) or metal content nor on the tolerance limits of metal (Nickel or Vanadium) poisons on the equilibrium catalyst.

U.S. Pat. No. 6,905,591 (Letszch, SWEC) is directed to a new catalytic reactor system as an improvement to above mentioned process, with two separate and distinct cracking zones with different radii to improve the selectivity of propene and butane products in a fluid catalytic cracking. The catalyst consists of commercially available rare earth exchanged zeolite component and a matrix component. There is no mention of feed metal content or the catalysts employed.

U.S. Pat. No. 5,846,402 (IOCL) discloses a process for selective catalytic cracking to produce 40-65 wt % of LPG containing at least 40 wt % of light olefins in a fluidized bed reactor operating with a catalyst to oil ratio of 15-25, riser temperature of 530-600° C. and employing a mixture or composite catalyst comprising ultrastable Y zeolite containing rare earth components, shape selective pentasil zeolite and a bottom cracking component. However vanadium tolerance of the catalyst is limited to 21,000 ppm only.

U.S. Pat. Nos. 6,149,875 (IOCL), 6,656,344 (IOCL) and 7,381,322 (IOCL) disclose a fluidized catalytic cracking apparatus in which riser shall have separate inlets for feedstock, regenerated catalyst and adsorbent while adsorbent and catalyst differ in their particle size and a separator to separate the adsorbent and catalyst. The adsorbents claim to adsorb undesired metal contaminants. To summarize, the single step reactor regenerator configuration based catalytic cracking processes can only handle a hydrocarbon feed stock with nickel content not exceeding 50 ppm to generate reasonable amount of hydrogen and low coke.

Patent application WO 2012004806 (IOCL) discloses a process that impregnates lanthanum oxide-based solution on base catalyst composite mixture by wet impregnation method.

Patent application US 2011132808 (BASF CORP) discloses a method of passivating and/or trapping at least one metal contaminant from a hydrocarbon oil feed in an FCC unit bed comprising contacting said hydrocarbon oil feed containing said at least one metal contaminant with a catalyst mixture comprising : 1) an FCC catalyst, and 2) a metal trap comprising a discrete particle comprising a matrix containing a calcined hydrous kaolin and dispersed therein a rare earth oxide (at least 5 wt %). Not mentioned about the metal level on equilibrium catalyst & selectivity and activity of the catalyst system.

U.S. Pat. No. 5,965,474 (MOBIL OIL CORP) discloses a composition for passivating metal contaminants in catalytic cracking of hydrocarbons includes a non-layered, ultra large pore crystalline material and a metal passivator incorporated within the crystalline material. A method for passivating contaminating metals uses the composition during catalytic cracking as an additive or as a component of the catalyst. Passivating agent is La₂O3 material as a discrete particle; could increase the conversion of vanadium doped catalyst by 53.2 wt % only with respect to the vanadium doped catalyst without additive by 37.5 wt %. That too this conversion (53.2 wt %) is achieved with very light feed i.e LET gas oil.

EP 0140007 (ASHLAND OIL INC) discloses an improvement for passivating deposited vanadium to reduce its degrading characteristics which comprises nonionic deposition of lanthanum or lanthanum-rich rare earths. zeolite catalyst is enriched with 1.2 wt % lanthanum.

U.S. Pat. No. 4,919,787 (MOBIL OIL CORP) discloses the usage of lanthanum oxide as passivating agent being incorporated into the matrix of cracking catalyst. The patent disclosure discloses the metal passivation of nickel. However the exact amount of nickel in equilibrium catalyst is not mentioned.

Additionally, there are mechanical methods in which highly metal laden catalysts are mechanically segregated. Due to low efficiency, high costs and complexity of operations, this method has not found many takers in the industry.

From the above details of the prevailing prior art, it is clear that there is urgent need in the indusry for a process for enhancing nickel tolerance of heavy hydrocarbon cracking catalysts.

The present invention discloses a high severity, single reactor-regenerator catalytic cracking process with high nickel tolerance to upgrade hydrocarbon feedstock, so that the catalyst can retain its activity up to 80,000 ppm nickel in the equilibrium catalyst, and yet possesses high activity to yield large quantities of light olefins and high octane gasoline, besides having excellent physical properties.

### OBJECTS OF THE INVENTION

An object of the invention is to provide a process for enhancing nickel tolerance of cracking catalysts for heavy hydrocarbon feedstocks. Hence the main aim of the invention is to reduce the dehydrogenation activity of nickel species that produce hydrogen and coke (which are not desired) and in turn affect operating profitability of a commercial unit while processing such feed stocks.

Another object of the invention is to provide a novel catalytic system for catalytic conversion of heavy resid feed stocks having very high nickel contaminant, yet produce substantially lower yields of hydrogen and coke.

Yet another object of the invention is to provide a process where the hydrocarbon feedstock has nickel as an impurity in the range of 50-150 ppm, and the hydrocarbon feed stock can be sourced from either petroleum derivatives or from coal, tar or sand.

A further object of the invention is to provide a process where the nickel content of the circulating equilibrium catalyst inventory is in the range of 40,000-60,000 ppm, most preferably up to 50,000 ppm, while maintaining excellent catalytic activity and selectivity.

Yet another object of the invention is to provide a process wherein the selectivity of propylene in LPG is considerably increased.

### SUMMARY OF THE INVENTION

The present invention provides a process for upgrading feed streams containing residual fractions with high concentrations of metals, more specifically nickel content up to 150 ppm employing acidic catalysts comprising large pore rare earth faujasite zeolite component, pentasil zeolite component and pseudoboehemite containing resid cracking component while the composite is impregnated with lanthanum oxide or aluminium oxide or mixture of both.

In general, in the catalytic cracking process, metal passivating agents are added to the catalyst during its manufacturing process as a part of catalyst formulation or added as separate additive particles, or added to feed during processing step. There is no reported catalyst system available that can effectively treat feed stocks containing more than 100 ppm nickel and equilibrium catalysts having more than 10,000 ppm nickel. The invention describes a method for effectively nullifying coke and dry gas generating tendency of nickel on composite catalyst system. This makes the catalyst system novel.

### DETAILED DESCRIPTION OF THE PROCESS

The invention will now be described in an exemplary embodiment. There may be other embodiments of the same invention, all of which are deemed covered by this description.

As the hydrocarbon becomes heavier in terms of density and Canradson Carbon Residue (CCR), it is expected that metals content also increase. This, however, holds good with certain aberrations. As the hydrocarbon density as well as CCR increases, metal levels do not always go up correspondingly in all cases. This is to imply that there are some light feeds which do contain abnormally high metals, even with lower density and CCR, as shown in Table 1 below. The hydrocarbon feedstock being treated in the process according to the invention has nickel as an impurity in the range of 50-150 ppm, and the hydrocarbon feed stock can be sourced from either petroleum derivatives or from coal, tar or sand.

TABLE 1

| | Unit | Case 1 | Case 2 | Case 3 | Case 4 | Case 5 |
|---|---|---|---|---|---|---|
| Density | kg/lit | 1.0467 | 1.0069 | 0.9961 | 1.035 | |
| CCR | wt % | 24 | 17.5 | 13.36 | 17.89 | 10.37 |
| Asphaltene | wt % | 14.2 | 10.6 | 4.75 | 5.2 | |
| Sulfur | wt % | 5.9 | 5.2 | 1.04 | 0.84 | 2.2 |
| Total | Ppm | 4315 | 3210 | 3490 | — | — |
| nitrogen | | | | | | |
| Ni | Ppm | 55 | 40 | — | 5 | 23.54 |
| V | Ppm | 145 | 95 | — | 2 | 51.71 |

### Feed Stocks

Feed stock for the present invention includes a wide range of heavy as well as hydrocarbon fractions starting from light fractions such as VGO, hydro treated VGO, hydro cracker bottom, untreated VGO, vacuum residue, RCO, SR, their mixtures, etc. The preferred types of feed stocks used in this invention are the residual fractions having metals (Ni+V) up to a value of 200 ppm, specifically nickel content to a value upto 150 ppm. Table 2 gives the properties of feed stock used in this invention.

TABLE 2
Properties of feedstock used

| Feed Properties | Unit | |
|---|---|---|
| Density @ 15° C. | gm/cc | 0.906 |
| CCR | wt % | 3.64 |
| Vanadium | ppm | 2.86 |
| Nickel | ppm | 75.89 |
| Sulfur | wt % | 0.64 |

### Catalysts

The catalyst system employed in this invention includes three types of active components in varied quantity, namely, medium pore pentasil zeolite component, large pore Y zeolite based component and very large pore acidic matrix component. Either all the said three components are mixed together after each component is separately prepared or a single catalyst is prepared by mixing suitable precursors of each component, spray dried to obtain micro spheres and final treatment given to obtain the said single catalyst constituting all the three components.

It is well known that the catalytic cracking process employs one or more components such as REY or USY, ZSM-5 and/or BCA. Sometimes, metal passivators are also added to negate the deleterious effects of unwanted metals.

However, in this invention the novel component has been impregnated with lanthanum oxide or aluminium oxide ranging from 2-8 wt % sourced from respective chlorides, sulfates, nitrates, carbonates, acetates, hydroxides and iso-propoxide which enhances the process to handle very heavy feed stocks having very high tolerance to metals more specifically nickel content, yet being able to operate in conventional cracking installations and under known process conditions, and yet yield very high light olefins as desired product without loss of its significant catalytic activity and selectivity to give low hydrogen and coke.

The nickel content of the circulating equilibrium catalyst inventory is in the range of 40,000-60000 ppm, most preferably up to 50,000 ppm, while maintaining excellent catalytic activity and selectivity in the process according to the present invention.

### Procedure for Coating on Base Catalyst

Preparation of catalyst involves heating of individual catalysts or composite catalyst to a temperature between 400-800° C. to eliminate volatile matter such as water moisture, any acidic/organic residue, then dissolving pre-calculated weight of lanthanum sourced from chloride/sulfate/nitrate/carbonate/acetate in deminaralized water/suitable solvent for loading La₂O₃ in weight range 2-8 wt %. Base catalyst composite mixture is then impregnated with thus prepared lanthanum oxide-based solution by wet impregnation method.

The catalyst system maintains its highest activity and selectivity at 5 wt % lanthanum oxide coating.

In another embodiment of the invention, catalyst composite mixture is impregnated with lanthanum oxide or aluminum oxide or mixture of both in the range of 1-10 wt % and most preferably in the range of 3-6 wt %. The aluminum is sourced from a chloride/sulphate/nitrate/hydroxide/iso-propoxide and mixture thereof.

This impregnated catalyst composite mixture is then oven dried at 120° C. for 3 hrs followed by calcination at 500° C. for 1 hr.

### Catalyst Composition

The catalyst composite mixture consists of ZSM-5 additive from 1-60 wt %, large pore Y zeolites based catalyst in the range 1-80 wt %, and alumina based bottom cracking additive in the range of 1-30 wt %. It is based on large pore zeolite which is either rare earth exchanged Y zeolite or Ultrastable Y zeolite or a mixture of both, total Y zeolite in the composite catalyst being in the range of 0.2-32 wt %, and most preferably in the range of 6-24 wt %. The ZSM-5 additive is based on pentasil zeolite concentration in the composite catalyst, which may be present in the range of 0.15-24 wt %, and most preferably in the range of 3.75-20 wt %.

Deployment of “Residue/bottom up-gradation additive” along with medium pore shape-selective pentasil zeolite based ZSM-5 additive and rare earth exchanged and/or fully ultra-stable Y zeolite based catalyst make the present invention novel and inventive.

The bottom upgradation additive is based on the large pore active matrix which is varied in the composite catalyst in the range of 0.2-12 wt % and most preferably in the range 1-8 wt %.

Table-3 summarizes the details (concentration of various components i.e. Y-zeolite based catalyst, medium pore pentasil zeolite based ZSM-5 additive, bottom upgradation additive and amount of coating) regarding CAT-A, CAT-B and CAT-C used in this study.

TABLE 3

| | | CAT-B | CAT-C |
|---|---|---|---|
| | | (Present invention | (Present invention |
| | | with high nickel | with high nickel |
| Catalyst | CAT-A | tolerance) | tolerance) |
| Y-zeolite based catalyst, | 40 | 40 | 40 |
| wt % | | | |
| Medium pore pentasil | 40 | 40 | 40 |
| zeolite based ZSM-5 | | | |
| additive, wt % | | | |
| Bottom upgradation | 20 | 20 | 20 |
| additive, wt % | | | |
| Lanthanum oxide | No | 3 | 2-8 |
| coating, wt % | | | |

Large pore acidic component present in residue upgradation additive is an “active alumina matrix”, which provides activity sites in larger pores which allow entry for larger heavy hydrocarbon molecules and which enable the cracking of higher-boiling and larger feedstock molecules. The cracked hydrocarbon molecules are further cracked by the rare earth exchanged and/or fully ultra-stable Y zeolite and pentasil based ZSM-5 additive. The “active alumina matrices” present in “residue up-gradation additive” of the present invention also serve as a metal trap component other than bottom cracking activity.

Nickel can exist in both oxidized (+2 valence state) and reduced (0 valence state) forms. Under FCC reactor conditions, nickel is present in reduced state and acts as a dehydrogenation catalyst producing high yields of hydrogen and coke. The extent of dehydrogenation depends upon the nickel content, the age of the nickel and cracking catalyst type. Under regenerator conditions nickel is in +2 valence state and produces high concentrations of CO₂ because it is catalytically active in that condition.

The nickel present in heavy hydrocarbon feedstocks under reactor conditions interact with components of “residue upgradation additive” and “Y-zeolite based catalyst” and form NiAl₂O₄ surface species. In steam-aged catalysts, silica is found to migrate to the surface where, in the presence of Ni, it forms inert NiSiO₃ like species. The “active alumina matrices” of the present invention are able to minimize nickel dispersion to form inert nickel species along with alumina and thereby increase the nickel tolerance of the catalyst system, since, nickel on alumina is difficult to reduce.

Further, the lanthanum coating of the present invention can act as a metal trap agent of nickel in a solid state compound making it unavailable for reduction to the zero valent state and inaccessible or inactive for subsequent dehydrogenation reactions. Further the lanthanum coating on the catalyst system can interact with alumina (present in “residue upgradation additive” and “Y-zeolite catalyst”) to form La—Al₂O₃ and inhibits the nickel aluminate (NiAl₂O₄) formation. Under regenerator conditions, the nickel oxide reacts with lanthanum to form a nickel lanthanum oxide LaNiO₃ thereby reducing the dehydrogenation reaction.

Therefore, both “active alumina matrices” and “lanthanum” compete with each other to reduce the dehydrogenation reaction caused by nickel and minimize the formation of coke and dry gas. The metal free hydrocarbon feedstocks are further cracked by Y-zeolite and pentasil zeolite and valuable products such as LPG and propylene are produced.

The novel catalyst system mentioned above enhances activity and selectivity considerably by shielding the catalyst mixture from the deleterious effects of nickel, by reducing formation of unwanted products such as hydrogen (3-20%), dry gas (9-35%) and coke (3-21%). Selectivity of propylene in LPG is increased in the range of 39-52%.

All the catalysts (A and B) were first metal doped by conventional Mitchell method (Ref: B R Mitchell “Metal contaminants of catalytic cracking” Ind Eng Chem Prod Res & Dev 209, 19, 1980) at different required nickel levels. Here the catalysts were doped with 0 ppm, 20,000 ppm, 35,000 ppm and 50,000 ppm of nickel. Then samples were steamed at 788° C. for 3 hours using 100% steam. The steamed catalyst was subjected to activity test in fixed bed Auto MAT unit under the typical conditions as shown in Table 4.

TABLE 4
Conditions

| | |
|---|---|
| Weight of catalyst loaded, gms | 3-3.5 |
| Feed Injection time, sec | 10-30 |
| Reactor temperature, ° C. | 500-580 |
| Feed rate, gm/min | 1.5-6 |
| Reaction Severity, W/F, Min | 0.5-1.5 |

After the completion of the reaction, the catalyst was stripped by nitrogen for 900 sec to remove adsorbed reaction products. Coke on catalyst is determined by in-situ regeneration with fluidized air by heating at 660° C. The gas sample is analyzed with online micro GC. The H₂, C1, C2, C3, C4 and C5 lump is determined quantitatively. The liquid products are analyzed by ASTM 2887 procedure in a simulated distillation analyzer, Perkin Elmer. The percentage of the liquid products boiling in the range of gasoline (C5-150° C.), heavy naphtha (C150-216° C.), light cycle oil (C-216° C.-370° C.) and clarified oil (370° C.+) is calculated. Carbon on catalyst is determined by online IR analyzer.

### EXAMPLE 1

Catalyst CAT-A was tested as such and its activity was evaluated in fixed bed Auto MAT unit under reaction conditions given in Table 4 and the products were analyzed as per the procedure mentioned above.

Table 5 compares the evaluation results of CAT-A which contains 10000 ppm, 20000 ppm, 35000 ppm and 50000 ppm of nickel and without lanthanum oxide impregnation.

TABLE 5

| | | | | | |
|---|---|---|---|---|---|
| CAT-A | 40:40:20 | 40:40:20 | 40:40:20 | 40:40:20 | 40:40:20 |
| Ni on CAT-A, ppm | 0 | 10000 | 20000 | 35000 | 50000 |
| ROT, ° C. | 550 | 550 | 550 | 550 | 550 |
| W/F, Min. | 1.0 | 1.0 | 1.0 | 1.0 | 1.0 |
| Yields, wt % | | | | | |
| Hydrogen | 0.14 | 0.73 | 1.15 | 1.38 | 1.52 |
| Dry Gas | 11.86 | 8.5 | 9.06 | 9.2 | 9.33 |
| LPG | 39.39 | 32.8 | 33.48 | 35.2 | 36.16 |
| C5+ | 36.03 | 41.77 | 36.98 | 33.12 | 30.14 |
| Coke | 12.58 | 16.2 | 19.33 | 21.1 | 22.85 |
| Total | 100 | 100 | 100 | 100 | 100 |
| Propylene (part of LPG) | 16.54 | 15.8 | 14.64 | 14.2 | 13.15 |
| % Selectivity of propylene | 41.99 | 48.17 | 43.73 | 40.34 | 36.37 |
| in LPG | | | | | |
| % Selectivity of ethylene in | 64.42 | 64.59 | 60.15 | 58.59 | 55.63 |
| DG | | | | | |

As can be seen, nickel on catalyst increases from 0 ppm to 50,000 ppm, the yields of hydrogen (from 01.4 wt % to 1.52 wt %) and coke (from 12.58 wt % to 22.85 wt %) increases due to dehydrogenation reaction. When the metal increases from 0 ppm to 10000 ppm LPG yield is reduced from 39.39 wt % to 32.8 wt % due to overall loss of activity. Further increase in nickel from 10,000 ppm to 50,000 ppm increases the LPG yield from 32.8 wt % to 36 wt %. However, the selectivity of propylene in LPG & ethylene in dry gas is reduced from 48.17 wt % to 36.37 wt % & 64.59 wt % to 55.63 wt %.

### EXAMPLE -2

Lanthanum oxide coated (3 wt %) catalyst CAT-B was doped with metal (10,000 ppm, 20000 ppm, 35000 ppm and 50,000 ppm) and steam deactivation procedure similar to that explained earlier. CAT-B was tested in fixed bed Auto MAT unit under reaction conditions given in Table 4 and the products were analyzed as per the procedure mentioned above. Table 6, compares the evaluation results of CAT-B which is treated for metal deactivation and is impregnated with varying amounts of nickel such as 10000 ppm, 20000 ppm, 35000 ppm and 50000 ppm.

TABLE 6

| | | | | | |
|---|---|---|---|---|---|
| CAT-B | 40:40:20 | 40:40:20 | 40:40:20 | 40:40:20 | 40:40:20 |
| Ni on CAT- | No metal | 10,000 | 20,000 | 35,000 | 50,000 |
| B, ppm | | | | | |
| La₂O₃ | No | 3 | 3 | 3 | 3 |
| coating, | coating | | | | |
| wt % | | | | | |
| ROT, ° C. | 550 | 550 | 550 | 550 | 550 |
| W/F, Min. | 1.0 | 1.0 | 1.0 | 1.0 | 1.0 |
| Yields, wt % | | | | | |
| Hydrogen | 0.14 | 0.55 | 0.94 | 1.22 | 1.46 |
| Dry Gas | 11.86 | 5.51 | 6.11 | 7.11 | 8.11 |
| LPG | 39.39 | 31.08 | 31.34 | 32.85 | 33.1 |
| C5+ | 36.03 | 50.05 | 43.84 | 40.12 | 35.26 |
| Coke | 12.58 | 12.81 | 17.77 | 18.7 | 22.07 |
| Total | 100 | 100 | 100 | 100 | 100 |
| Propylene | 16.54 | 16.01 | 15.76 | 15.04 | 13.00 |
| (part of | | | | | |
| LPG) | | | | | |
| % Selectivity | 41.99 | 51.51 | 50.29 | 45.78 | 39.27 |
| of propylene | | | | | |
| in LPG | | | | | |
| % Selectivity | 64.42 | 56.62 | 54.34 | 52.60 | 52.04 |
| of ethylene | | | | | |
| in DG | | | | | |

As can be seen, CAT-B decreases hydrogen (3-20%), dry gas (9-35%) and coke (3-21%) yields (Table-6) when compared to the CAT-A (Table-5) at the metal level of 10,000 ppm, 20000 ppm, 35000 ppm, 50000 ppm. The above indicates the dehydrogenation effect of nickel is reduced by lanthanum oxide coating. The selectivity of propylene in LPG is in the range of 39-52% for the La₂O₃ coated sample which is higher than the CAT-A, which is in the range of 36-48%.

### EXAMPLE -3

Table-7 shows the effect of varying lanthanum concentration on CAT-C at metal level of 50000 ppm nickel. As can be seen, CAT-C gives the optimized. LPG yield (34.16 wt %) and propylene selectivity in LPG (41.13%) at 5 wt % lanthanum oxide coating. Further increasing the lanthanum coating i.e., 6 wt % and 8 wt % with the same metal level reduced the activity and selectivity of lighter hydrocarbon.

TABLE 7

| | | | | | |
|---|---|---|---|---|---|
| CAT-C | 40:40:20 | 40:40:20 | 40:40:20 | 40:40:20 | 40:40:20 |
| Ni on | 50,000 | 50,000 | 50,000 | 50,000 | 50,000 |
| CAT-C, | | | | | |
| ppm | | | | | |
| La₂O₃ | 2 | 3 | 5 | 6 | 8 |
| coating, | | | | | |
| wt % | | | | | |
| ROT, ° C. | 550 | 550 | 550 | 550 | 550 |
| W/F, Min. | 1 | 1 | 1 | 1 | 1 |
| Yields, wt % | | | | | |
| Hydrogen | 1.49 | 1.46 | 1.35 | 1.33 | 1.31 |
| Dry Gas | 8.61 | 8.11 | 7.61 | 7.57 | 7.32 |
| LPG | 32.11 | 33.1 | 34.16 | 33.05 | 32.12 |
| C5+ | 33.78 | 35.26 | 35.62 | 37.79 | 40.45 |
| Coke | 24.01 | 22.07 | 21.26 | 20.26 | 18.8 |
| Total | 100 | 100 | 100 | 100 | 100 |
| Propylene | 11.85 | 13 | 14.05 | 12.89 | 11.52 |
| (part of | | | | | |
| LPG) | | | | | |
| % Selectivity | 36.90 | 39.27 | 41.13 | 39.00 | 35.87 |
| of propylene | | | | | |
| in LPG | | | | | |
| % Selectivity | 53.77 | 52.04 | 50.85 | 50.33 | 49.04 |
| of ethylene | | | | | |
| in DG | | | | | |

We claim:

1. A process for enhancing nickel tolerance of heavy hydrocarbon cracking catalysts for treating heavy hydrocarbon feedstocks from various petroleum fractions including heavy residual oils containing high metal content, more specifically nickel, the process comprising the steps of:
heating of individual catalysts or composite catalyst to a temperature between 400-800° C.;
dissolving pre-calculated weight of lanthanum sourced from chloride/sulfate/nitrate/carbonate/acetate in demineralized water or suitable solvent to prepare lanthanum oxide-based solution;
impregnating the base catalyst composite mixture with thus prepared lanthanum oxide-based solution by wet impregnation method; and
oven drying at 120° C. for 3 hrs followed by calcination at 500° C. for 1 hour the impregnated catalyst composite mixture.

1. The process for enhancing nickel tolerance of heavy hydrocarbon cracking catalysts as claimed in claim 1, wherein the composite catalyst is alternatively treated with aluminum oxide or mixture of lanthanum oxide and aluminum oxide in the range of 1-10 wt % and most preferably in the range of 3-6 wt %.

2. The process for enhancing nickel tolerance of heavy hydrocarbon cracking catalysts as claimed in claim 1, wherein the composite catalyst comprises of residue/bottom upgradation additive along with medium pore shape-selective pentasil zeolite based ZSM-5 additive and rare earth exchanged and/or fully ultra stable Y zeolite based catalyst.

3. The process for enhancing nickel tolerance of heavy hydrocarbon cracking catalysts as claimed in claim 3, wherein the composite catalyst contains ZSM-5 additive in the range of 1-60 wt %, large pore Y zeolites based catalyst in the range 1-80 wt %, and alumina based bottom cracking additive in the range of 1-30 wt %.

4. The process for enhancing nickel tolerance of heavy hydrocarbon cracking catalysts as claimed in claim 3, wherein the composite catalyst mixture is based on large pore zeolite which is either rare earth exchanged Y zeolite or Ultrastable Y zeolite or a mixture of both, total Y zeolite in the composite catalyst being in the range of 0.2-32 wt %, and most preferably in the range of 6-24 wt %.

5. The process for enhancing nickel tolerance of heavy hydrocarbon cracking catalysts as claimed in claim 3, wherein the ZSM-5 additive is based on pentasil zeolite concentration in the composite catalyst, which may be present in the range of 0.15-24 wt %, and most preferably in the range of 3.75-20 wt %.

6. The process for enhancing nickel tolerance of heavy hydrocarbon cracking catalysts as claimed in claim 3, wherein the bottom upgradation additive is based on the large pore active matrix which is varied in the composite catalyst in the range of 0.2-12 wt % and most preferably in the range 1-8 wt %.

7. The process for enhancing nickel tolerance of heavy hydrocarbon cracking catalysts as claimed in claim 1, wherein the hydrocarbon feedstock has nickel as an impurity in the range of 50-150 ppm, and the hydrocarbon feed stock can be sourced from either petroleum derivatives or from coal, tar or sand.

8. The process for enhancing nickel tolerance of heavy hydrocarbon cracking catalysts as claimed in claim 1, wherein the nickel content of the circulating equilibrium catalyst inventory is in the range of 40,000-60,000 ppm, most preferably up to 50,000 ppm, while maintaining excellent catalytic activity and selectivity in the said process.

9. The process for enhancing nickel tolerance of heavy hydrocarbon cracking catalysts as claimed in claim 1, wherein the selectivity of propylene in LPG is increased in the range of 39-52%.

10. The process for enhancing nickel tolerance of heavy hydrocarbon cracking catalysts as claimed in claim 1, wherein the catalyst system maintains its highest activity and selectivity at 5 wt % lanthanum oxide coating.
